(19) United States
(12) Patent Application Publication
(10) Pub. No.: US 2016/0342501 A1
(43) Pub. Date: Nov. 24, 2016

(54) Accelerating Automated Testing

(71) Applicant: HCL Technologies Limited, Uttar Pradesh (IN)

(72) Inventors: Rajesh Venkatesan, Tamil Nadu (IN); Kirthiga Balaji Srinivasan, Tamil Nadu (IN); Vidhya Muthamil Selvan, Tamil Nadu (IN); Madhava Venkatesh Raghavan, Tamil Nadu (IN); Sezhiyan Navarasu, Tamil Nadu (IN)

(21) Appl. No.: 15/074,229

(22) Filed: Mar. 18, 2016

(30) Foreign Application Priority Data
May 18, 2015 (IN) 1395/DEL/2015

(51) Int. Cl. G06F 11/36

(52) U.S. Cl. CPC G06F 11/3684

(57) ABSTRACT

System and method for accelerating automated testing is disclosed. First, a test script of a screen is recorded to identify user interface elements comprising data fields present on the screen. An input is received in the data fields. Based on the input, one or more test case templates are selected. Further, data sets and verification types required corresponding to the input are obtained. The data sets are obtained based on the one or more test case templates. The verification types are obtained from a user. Subsequently, the one or more test case templates, the data sets, and the verification types are integrated to generate an executable test case file. Based on the executable test case file, the test script is modified and further executed. Upon executing, a report is generated.

### CROSS REFERENCE TO RELATED APPLICATIONS

The present application claims benefit from Indian Complete Patent Application No. 1395/DEL/2015, filed on 18 May 2015, the entirety of which is hereby incorporated by reference.

### TECHNICAL FIELD

The present disclosure in general relates to a field of automatic testing of applications. More particularly, the present disclosure relates to a system and a method for accelerating automated testing.

### BACKGROUND

Typically, automated testing is used to control execution of tests and the comparison of actual outcomes with predicted outcomes. Generally, automated testing automates some repetitive tasks in a testing process that are difficult to perform manually. Traditionally, a tester designs test data manually. In order to design the test data, the tester should have domain knowledge. Further, the tester needs to validate the test data and then map the test cases with the test case for executing the tests.

In order to execute the tests, the tester should record a test script associated with an application and therefore the tester should have proficiency in a scripting language. Further, maintaining of the test script recorded is difficult. The test script recorded may be improved to execute the tests without any intervention. In order to improve the execution of the test scripts, the tester typically manipulates the test scripts manually. Manipulating the test scripts requires lot of time and is tedious.

### SUMMARY

This summary is provided to introduce concepts related to systems and methods of accelerating automated testing and the concepts are further described below in the detailed description. This summary is not intended to identify essential features of the claimed subject matter nor is it intended for use in determining or limiting the scope of the claimed subject matter.

In one implementation, a method of accelerating automated testing is disclosed. The method comprises recording, by a processor, a test script of a screen, to identify user interface elements present on the screen. The user interface elements comprise data fields. The user interface elements are identified by parsing the test script of the screen. The method further comprises receiving, by the processor, an input in the data fields. The method further comprises selecting, by the processor, one or more test case templates based on the input. The test case templates are selected from a test case repository. The method further comprises obtaining one or more test types required from a plurality of test types to select the one or more test cases. The method further comprises obtaining, by the processor, data sets and verification types required corresponding to the input. The data sets are obtained based on the one or more test case templates. The verification types are obtained from a list of feasible verification types, by a user. The method further comprises integrating, by the processor, the one or more test case templates, the data sets, and the verification types to generate an executable test case file. The method further comprises modifying, by the processor, the test script based on the executable test case file generated to execute the test script for testing the screen. The method further comprises mapping the data fields with data associated with a domain model of the screen. The method further comprises generating a report based on the execution of the test script.

In one implementation, a system for accelerating automated testing is disclosed. The system comprises a processor and a memory coupled to the processor. The processor executes processor executes program instructions stored in the memory. The processor executes the program instructions to record a test script of a screen, to identify user interface elements present on the screen. The user interface elements comprise data fields. The user interface elements are identified by parsing the test script of the screen. The processor further executes the program instructions to receive an input in the data fields. The processor further executes the program instructions to select one or more test case templates based on the input. The test case templates are selected from a test case repository. The processor further executes the program instructions to obtain one or more test types required from a plurality of test types to select the one or more test cases. The processor further executes the program instructions to obtain data sets and verification types required corresponding to the input. The data sets are obtained based on the one or more test case templates. The verification types are obtained from a list of feasible verification types, by a user. The processor further executes the program instructions to integrate the one or more test case templates, the data sets, and the verification types to generate an executable test case file. The processor further executes the program instructions to modify the test script based on the executable test case file generated to execute the test script for testing the screen. The processor further executes the program instructions to generate a report based on the execution of the test script. The processor further executes the program instructions to map the data fields with data associated with a domain model of the screen.

In one implementation, a non-transitory computer readable medium embodying a program executable in a computing device for accelerating automated testing is disclosed. The program comprises a program code for recording a test script of a screen, to identify user interface elements present on the screen. The user interface elements comprise data fields. The program further comprises a program code for receiving an input in the data fields. The program further comprises a program code for selecting one or more test case templates based on the input. The program further comprises a program code for obtaining data sets and verification types required corresponding to the input. The data sets are obtained based on the one or more test case templates. The verification types are obtained from a list of feasible verification types, a user. The program further comprises a program code for integrating the one or more test case templates, the data sets, and the verification types to generate an executable test case file. The program further comprises a program code for modifying the test script based on the executable test case file generated to execute the test script for testing the screen.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system for accelerating automated testing, in accordance with an embodiment of the present disclosure.

FIG. 2 illustrates the system, in accordance with an embodiment of the present disclosure.

FIG. 3 illustrates an exemplary categorization of the dictionary, in accordance with an embodiment of the present disclosure.

FIG. 4 shows test script captured, in accordance with an embodiment of the present disclosure.

FIG. 5 shows test script modified/manipulated, in accordance with an embodiment of the present disclosure.

FIG. 6 shows a flowchart for accelerating automated testing, in accordance with an embodiment of the present disclosure.

### DETAILED DESCRIPTION

The present disclosure relates to a system and a method for accelerating automated testing. In order to accelerate the automated testing, at first, a user may record a test script of a screen for testing. Subsequently, the test script recorded may be parsed to identify User Interface (UI) elements present in the screen. The UI elements may comprise data fields. After identifying, the UI elements may be mapped with data associated with a domain model of the screen. Subsequently, the user may be prompted to obtain one or more test types required from a plurality of test types to select one or more test case templates. The one or more test case templates may be selected from a test case repository. After selecting, the one or more test case templates may be mapped to a data set. Specifically, the one or more test case templates may be mapped using a data lexicon.

Further, the data set and verification types required for test may be obtained. The verification types may be obtained from a list of feasible verification types. After obtaining the test data and the verification types, the system may integrate the one or more test case templates, the data sets and the verification types to generate an executable test case file. Subsequently, the test script of the screen recorded may be modified to read data from the executable test case file generated. The test script modified may be executed over an application under test. Upon executing the test script modified, a report may be generated.

While aspects of described system and method for accelerating automated testing may be implemented in any number of different computing systems, environments, and/or configurations, the embodiments are described in the context of the following exemplary system.

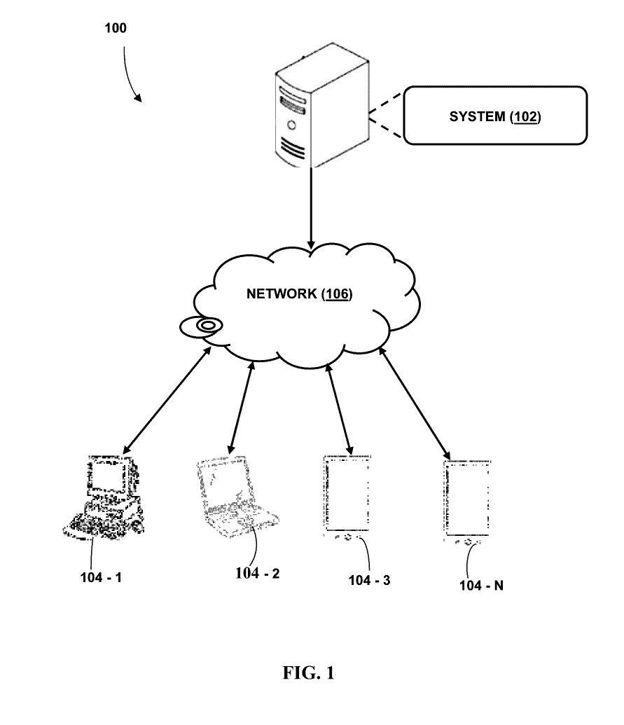

Referring now to FIG. 1, a network implementation 100 of a system 102 for accelerating automated testing is illustrated, in accordance with an embodiment of the present disclosure. The system 102 may record a test script of a screen, to identify user interface elements present on the screen. The user interface elements may comprise data fields. The system 102 may identify the user interface elements by parsing the test script of the screen. The system 102 may receive an input in the data fields. Based on the input, the system 102 may select one or more test case templates. Further, the system 102 may obtain one or more test types required from a plurality of test types to select the one or more test cases. The system 102 may obtain test data/data set and verification types required corresponding to the input. The data sets may be obtained based on the one or more test case templates. The verification types may be from a list of feasible verification types by a user. The system 102 may integrate the one or more test case templates, the data sets, and the verification types to generate an executable test case file. Subsequently, the system 102 may modify the test script based on the executable test case file generated to execute the test script for testing the screen. After executing the modified test script, the system 102 may generate a report.

Although the present disclosure is explained by considering that the system 102 is implemented on a server, it may be understood that the system 102 may also be implemented in a variety of computing systems, such as a laptop computer, a desktop computer, a notebook, a workstation, a mainframe computer, a server, a network server, cloud, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

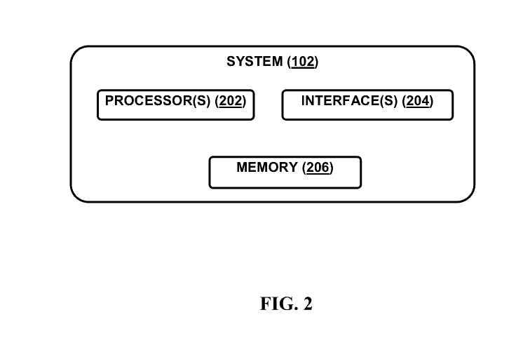

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, at first, the user may use the client device 104 to access the system 102 via the I/O interface 204. The working of the system 102 may be explained in detail using FIG. 2 to FIG. 5. The system 102 may be used for accelerating automated testing. For accelerating the automated testing, at first, a screen under test may be considered. The screen may an active window on a Graphical User Interface (GUI) of a computer. For example, the screen may comprise a login page. In another example, the screen may comprise an application form. As known, the screen may comprise User Interface (UI) elements indicating sections on the screen. For example, a screen may have several sections, where each section represents a particular type of data. For example, a screen may have a section for personal information, a section for a photo of a user, a section of signature, and so on. Further, the UI elements may comprise data fields. The data fields may be provided to receive an input from a user. For example, the data fields may comprise, name, occupation, address, and so on in an application form such that the user may fill-in details in each data field.

For accelerating the automated testing, the UI elements in the screen may be identified. The UI elements may be identified by parsing the active window or active page on the screen. In another implementation, a test script of the screen that records the UI elements on the screen may be captured/recorded. The test script may be recorded using a record and a playback tool. For example, the record and playback tool, such as Selenium IDE may be used to record the test script. After recording, the test script may be exported to a scripting language. The test script exported may be used for further processing of the UI elements.

As presented above, the UI elements may have the data fields. In order to test the screen, the system 102 may receive an input from a user in the data fields. Generally, the screen may be of three test types, such as read only screen, domain specific screen and read and write. In the read only screen test type, the screen may display data without requiring an input. For example, the screen comprising a dashboard, a reporting page and so on may indicate the read only screen. The domain specific screen may indicate a logic screen that is specific to data on a higher level. For example, a data field comprising a year of calendar may indicate the domain specific screen. In the read and write screen, the screen may display data and the input required from the user. For example, the read and write screen may include a screen comprising the data fields capturing financial details of a user.

The system 102 may identify the UI elements based on the test type screen. In other words, the system 102 may identify the UI elements on the screen using the pattern of the screen. Specifically, the system 102 may identify the UI elements by looking for disabled or read only attributes of the UI elements on the screen. Further, based on the input requested from the user, the system 102 may obtain one or more test types required from a plurality of test types. The test types may include assertion of displayed data in a data field, a positive test for a field, a negative test for a field, a divide by zero tests, a range test, an equivalence partitioning test, and so on. For example, consider the data field requested is name of a user. For the data field, the characters provided by the user should be alphabets. Similarly, if the data field requested is age of the user, then the characters provided by the user should numeric. Similarly, for each test type, the input is obtained and checked with the list of test types that are feasible in the data fields.

After receiving the input from the user, the system 102 may use the input to select one or more test case templates required for testing the screen. In one implementation, the system 102 may select the one or more test case templates from a test case repository. In order to accurately select the one or more test case templates, the test case repository comprising a plurality of test case templates may be classified into a plurality of domain specific test case templates and a plurality of general test case templates.

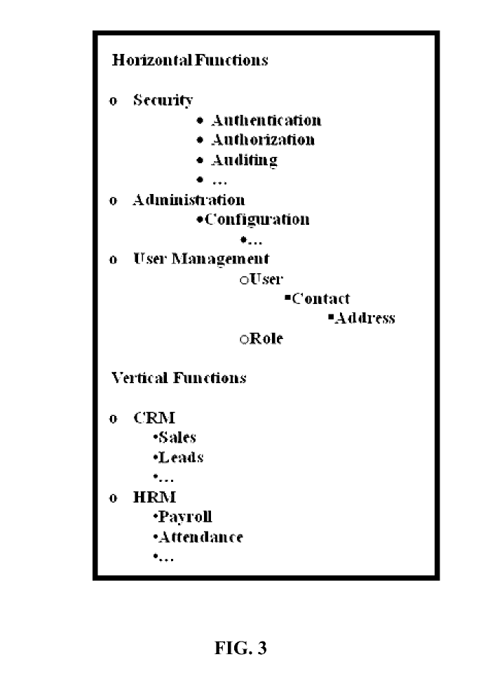

In order to explain the domain specific test case templates, an example may be used. Consider a Human Resource (HR) application illustrating payroll of an organization. The HR application may have the data fields such as Employee ID, Department, Number of days worked, pay per day, and so on. When the data fields are displayed on the user interface, the data fields may be mapped with data associated with a domain model of the screen. For example, the data field ‘number of days worked’ in the user interface may be mapped with a corresponding field in the domain model. The data in the domain model may be associated with a data set. The data set for the application under test may be obtained from a data lexicon or a data dictionary. In other words, the data lexicon or the data dictionary is a warehouse for test data from which the system 102 may extract the data to test the screen. If the test data is not sufficient, then the data lexicon is updated to obtain the data set. Specifically, if the test data is insufficient or new data is identified, the warehouse may be updated with the new data such that the new data may be used for other applications. The data warehouse may categorize the data available in the data dictionary under various categories. For example, the data lexicon may categorize the data based on horizontal and vertical functions available in the data, as shown in FIG. 3. Referring to FIG. 3, the horizontal and vertical functions for the HR application is shown. The horizontal functions may include a security, an administration and a user management. The vertical functions may include a Customer Relationship Management (CRM) and a Human Resource management (HRM). As shown in FIG. 3, the security may have sub-functions such as authentication, authorization and auditing, and so on. The administration may have configuration. The user management may comprise user and role. The user in the user management may further comprise contact. Further, the contact may include address of the user. For the vertical functions, the CRM may comprise sales and leads as sub-functions. Further, the HRM may comprise payroll and attendance as sub-functions. The categorization of the data model based on the structure i.e., hierarchy is important to identify the test cases relevant to the data model.

Using the above example for domain specific test case templates, the data field comprising ‘number of days worked’, the data ranging from 0 to 31 may be available in the data set for a positive testing in the data lexicon. The data below 0 and above 31 may be considered as negative testing. Similarly, the data fields that require only ASCII characters may be related to the data lexicon data set that provides only the ASCII values as the input.

Performing the positive testing and the negative testing for the test case templates with the test data is explained using the HR application presented above. At first, the data field ‘Emp ID’ allowing only the input which is numeric may be checked. For positive testing, the input may be linked with the test data in the data lexicon that has only the numeric. Further, for performing the negative testing, the input may be linked with the test data in the data lexicon that has alphanumeric and special characters. Further, the data field ‘department’ may be checked for presence in the organization. In order to check the ‘department’, positive testing may be performed by linking the data field with the test data in the data lexicon that contains ‘department’ and exists in the organization. Further, negative testing is performed by linking the data field with the test data in the data lexicon that contains department and that do not exist in the organization. Similarly, the data fields such as ‘number of days’, ‘pay per day’ and so on are checked by linking the data fields with test data in the data lexicon.

After performing the positive testing and the negative testing on the data fields, the system 102 may check whether a ‘save option’ saves the valid data. Further, the system 102 may check whether an ‘update option’ retains previous information in the memory 206. Further, the system 102 may check whether a ‘delete option’ deletes the data from the memory 206. Furthermore, the system 102 may check whether the ‘delete option’ retains the data in the memory 206 after deleting the data. Furthermore, the system, 102 may check whether an ‘exit option’ results in closure of a program or not.

Similar to the domain specific test case templates, the general test case templates may be obtained from the test case repository. The general test case templates may indicate that all mandatory data fields in the application should be validated. In one example, the mandatory data fields may be marked as *. Further, the input received from the user may have to be within a specified range. For example, the data field ‘employee name’ should have a minimum of 3 characters to a maximum of 20 characters. Subsequently, the input received may be linked with the test data in the data lexicon that has data values within a range, outside of the range and on boundary of accepted values. Further, the input may be checked for blank spaces before first character and after last character. The input may be linked with the test data in the data lexicon that has whitespace characters at the start and end. As known, in case of any error in the data inputted, displaying of the error message at a position pre-defined may be validated. Furthermore, when the input comprises numeric values, the input may be checked for format of the numbers. Similarly, while performing calculations using the input, the calculations may be verified for divide by zero errors. The calculations performed may be linked with the test data in the data lexicon that has zero as input value. Further, currency values received as the input should be inputted with valid currency symbols. For example, 50 US dollars should be inputted as US $50.

After obtaining the data sets corresponding to the input and the test case templates, the system 102 may obtain verification types required to verify the test cases. For example, when a create/add operation present on the screen, the operation needs to be tested. In order to test the operation, a verification type that an entity is added to the application may have to be performed. Further, the user may verify text displayed as a success message or a failure message, and a position of the success message or the failure message in the user interface. In order to perform the verification, appropriate verification types may have to be selected and the verification types may have to be mapped based on a scenario of the application. For selecting the appropriate verification types, all feasible verification types may be listed. Based on the test type, a verification type may be obtained by the user from the list. In one example, the verification types may comprise database records, user interface elements matching and a target Uniform Resource Identifier (URL). The database records may indicate matching of the input received with records pre-stored in the database. The user interface elements may indicate matching of attributes of the UI elements displayed on the screen. In one example, the user interface elements matching may comprise text match, position or path match, or colour match. The target URL verification type may indicate a subsequent link or URL or window to be opened when an option is selected on a current window.

Obtaining the verification types may allow the user to map the screen values to columns in the database, provide the URL to which the screen should transit upon success or failure. If the transition is a failure, then the error message should display a problem associated with the error at a pre-defined location. Based on the success or the failure message, the user may choose from the list of available options and provide appropriate input.

After obtaining the data sets and the verification types required, the system 102 may integrate the data sets, the test case templates selected and the verifications types obtained. Specifically, the data sets, the test case templates and the verifications types are integrated to generate an executable test case file. The executable test case file may be generated to inject to the test script recorded for the actual UI elements of the screen. In one example, the executable test case file may be a spreadsheet file or an excel sheet or a relational database. As discussed, the test script may be recorded using the record and playback tool, such as Selenium IDE. In order to generate the executable test case file, the test script recorded may be exported to a scripting language. The test script exported may serve as an input to identify the UI elements in the screen and to read data by modifying or manipulating the test script. In order to manipulate the test script, the system 102 may append a code snippet for every test case identified. The system 102 may read the data from an external source, generate the code for verifications, and may update results to an external file. In other words, the system 102 may take the test script of the screen that is recorded as input and may modify the test script with the list of test cases, a test data source to feed the test cases and appropriate verification types for confirming that the tests pass or fail.

For example, consider the screen comprises of receiving the input of payroll for processing salary. Consider the data fields include Employee ID, Number of Days, and pay per day are recognised at the domain level. As discussed above, the test data for the data fields may be obtained from the data lexicon, the test case templates that are to be executed for testing are selected and the verification types are obtained based on the test types. In order to illustrate the test case template, data sets and the verification types obtained, Table 1 may be used as an example.

TABLE 1
Table 1: Test case templates

| Test | |
|---|---|
| case_ID | Test case |
| TC_1 | Check number of days data field only accepts numeric data |
| TC_2 | Check the salary data field for the calculation |
| | (number of days * per day pay) |
| TC_3 | Check if the save button saves the valid data |

TABLE 2
Table 2: Test case template, test data and the verification type

| | Emp | Number of | Pay | Verification | Verification |
|---|---|---|---|---|---|
| Test case_ID | ID | days | per day | type | item |
| TC_1 | 1 | Abc | | Verify Alert | Enter valid |
| | | | | present | number |
| TC_2 | 2 | 31 | 1000 | | 31000 |
| TC_3 | 3 | | | | Employee |
| | | | | | salary |
| | | | | | updated |
| | | | | | successfully |

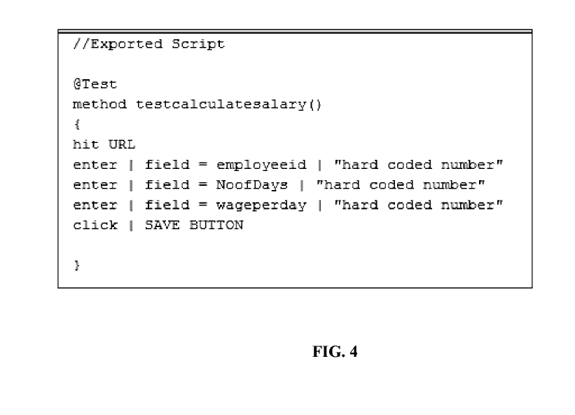

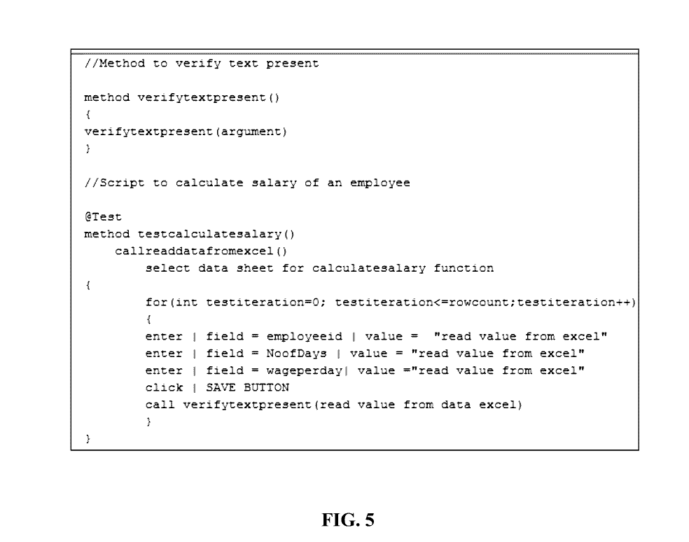

Table 1 and Table 2 illustrate the test case template, the test data and the verification type including attributes provided to generate the executable test case file. The test script for the above example is shown in FIG. 4. After modifying the test script based on the executable test case file, the test script modified may be presented as shown in FIG. 5. After modifying the test script, the system 102 may execute the test script. Upon execution, the system 102 may generate a report corresponding to a functional testing of the screen. In one implementation, the system 102 may generate the report in a human readable format.

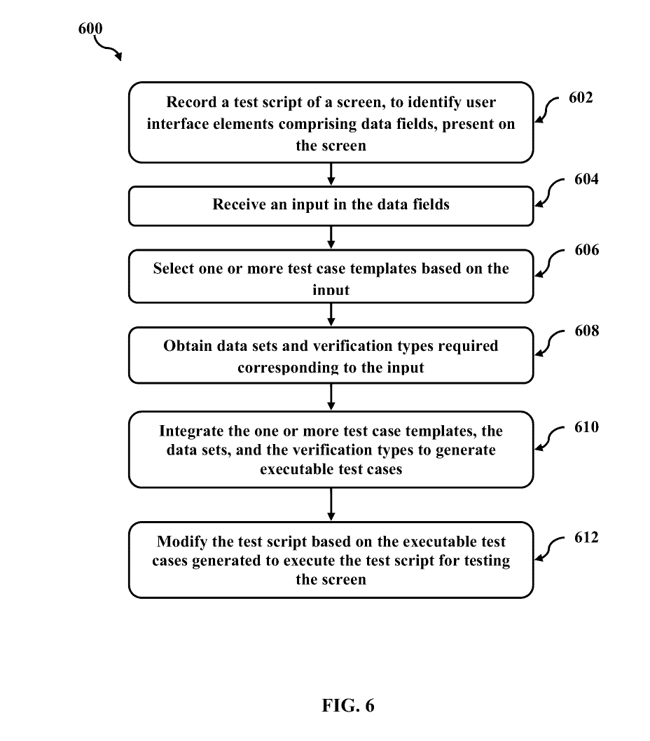

Referring now to FIG. 6, a method 600 for accelerating automated testing is shown, in accordance with an embodiment of the present disclosure. The method 600 may be described in the general context of computer executable instructions. Generally, computer executable instructions can include routines, programs, objects, components, data structures, procedures, modules, functions, etc., that perform particular functions or implement particular abstract data types. The method 600 may also be practiced in a distributed computing environment where functions are performed by remote processing devices that are linked through a communications network. In a distributed computing environment, computer executable instructions may be located in both local and remote computer storage media, including memory storage devices.

The order in which the method 600 is described and is not intended to be construed as a limitation, and any number of the described method blocks can be combined in any order to implement the method 600 or alternate methods. Additionally, individual blocks may be deleted from the method 600 without departing from the spirit and scope of the disclosure described herein. Furthermore, the method may be implemented in any suitable hardware, software, firmware, or combination thereof. However, for ease of explanation, in the embodiments described below, the method 600 may be implemented in the above-described system 102.

At step/block 602, a test script of a screen may be recorded to identify user interface elements present on the screen. The user interface elements may comprise data fields.

At step/block 604, an input in the data fields may be received.

At step/block 606, one or more test case templates may be selected based on the input.

At step/block 608, test data and verification types required corresponding to the input may be obtained. The test data may be obtained based on the one or more test case templates. The verification types may be obtained from a list of feasible verification types by a user.

At step/block 610, the one or more test case templates, the test data, and the verification types may be integrated to generate an executable test case file.

At step/block 612, the test script may be modified based on the executable test case file generated to execute the test script for testing the screen.

Although implementations of system and method for accelerating automated testing have been described in language specific to structural features and/or methods, it is to be understood that the appended claims are not necessarily limited to the specific features or methods described. Rather, the specific features and methods are disclosed as examples of implementations for accelerating automated testing.

We claim:

1. A method of accelerating automated testing, the method comprising:
recording, by a processor, a test script of a screen, to identify user interface elements present on the screen, wherein the user interface elements comprises data fields;
receiving, by the processor, an input in the data fields;
selecting, by the processor, one or more test case templates based on the input;
obtaining, by the processor, data sets and verification types required corresponding to the input, wherein the data sets are obtained based on the one or more test case templates, and wherein the verification types are obtained from a user;
integrating, by the processor, the one or more test case templates, the data sets, and the verification types to generate an executable test case file; and
modifying, by the processor, the test script based on the executable test case file generated to execute the test script for testing the screen.

2. The method of claim 1, wherein the user interface elements are identified by parsing the test script of the screen.

3. The method of claim 1, further comprising mapping the data fields with data associated with a domain model of the screen.

4. The method of claim 1, further comprising obtaining one or more test types required from a plurality of test types to select the one or more test cases.

5. The method of claim 1, wherein the test case templates are selected from a test case repository.

6. The method of claim 1, further comprising generating a report based on the execution of the test script.

7. A system for accelerating automated testing, the system comprising:
a processor; and
a memory, coupled to the processor, wherein the processor executes processor executes program instructions stored in the memory, to:
record a test script of a screen, to identify user interface elements present on the screen, wherein the user interface elements comprise data fields;
receive an input in the data fields;
select one or more test case templates based on the input;
obtain data sets and verification types required corresponding to the input, wherein the data sets are obtained based on the one or more test case templates, and wherein the verification types are obtained from a user;
integrate the one or more test case templates, the data sets, and the verification types to generate an executable test case file; and
modify the test script based on the executable test case file generated to execute the test script for testing the screen.

8. The system of claim 7, wherein the user interface elements are identified by parsing the test script of the screen.

9. The system of claim 7, wherein the processor further executes the program instructions to map the data fields with data associated with a domain model of the screen.

10. The system of claim 7, wherein the processor further executes the program instructions to obtain one or more test types required from a plurality of test types to select the one or more test cases.

11. The system of claim 7, wherein the test case templates are selected from a test case repository.

12. The system of claim 7, wherein the processor further executes the program instructions to generate a report based on the execution of the test script.

13. The system of claim 7, wherein the data sets are obtained from a data lexicon corresponding to the one or more test case templates selected.

14. A non-transitory computer readable medium embodying a program executable in a computing device for accelerating automated testing, the program comprising:
a program code for recording test script of a screen, to identify user interface elements present on the screen, wherein the user interface elements comprise data fields;
a program code for receiving an input in the data fields;
a program code for selecting one or more test case templates based on the input;
a program code for obtaining data sets and verification types required corresponding to the input, wherein the data sets are obtained based on the one or more test case templates, and wherein the verification types are obtained from a user;
a program code for integrating the one or more test case templates, the data sets, and the verification types to generate an executable test case file; and
a program code for modifying the test script based on the executable test case file generated to execute the test script for testing the screen.
